(19) United States
(12) Patent Application Publication
(10) Pub. No.: US 2024/0088578 A1
(43) Pub. Date: Mar. 14, 2024

(54) LEAD TERMINAL COMPRISING AT LEAST ONE SPRING-LOADED CLAMPING CONNECTION

(71) Applicant: WAGO Verwaltungsgesellschaft mbH, Minden (DE)

(72) Inventor: Michael MEYER, Wiedensahl (DE)

(73) Assignee: WAGO Verwaltungsgesellschaft mbH, Minden (DE)

(21) Appl. No.: 18/512,159

(22) Filed: Nov. 17, 2023

Related U.S. Application Data
(63) Continuation of application No. PCT/EP2022/063286, filed on May 17, 2022.

(30) Foreign Application Priority Data
May 19, 2021 (DE) 10 2021 112 960.5

(51) Int. Cl. H01R 4/48

(52) U.S. Cl. CPC H01R 4/483

(57) ABSTRACT

A lead terminal comprising at least one spring-loaded clamping connection for connecting an electrical conductor by spring force. The spring-loaded clamping connection includes a clamping spring and a busbar section, associated with the clamping spring, between which a clamping point for connecting the electrical conductor is formed, and comprising a swivelable actuating lever, associated with the spring-loaded clamping connection, for actuating the clamping spring. The actuating lever has at least one support element that includes a support surface, facing the busbar section, via which the actuating lever is supported on a support region of the busbar section.

This nonprovisional application is a continuation of International Application No. PCT/EP2022/063286, which was filed on May 17, 2022, and which claims priority to German Patent Application No. 10 2021 112 960.5, which was filed in Germany on May 19, 2021, and which are both herein incorporated by reference.

### BACKGROUND OF THE INVENTION

### Field of the Invention

The invention relates to a lead terminal comprising at least one spring-loaded clamping connection for connection of an electrical conductor by spring force, the spring-loaded clamping connection comprising a clamping spring and a busbar section associated with the clamping spring, between which a clamping point for connecting the electrical conductor is formed, and comprising a swivelable actuating lever, associated with the spring-loaded clamping connection, for actuating the clamping spring, the actuating lever having at least one support element that includes a support surface, facing the busbar section, via which the actuating lever is supported on a support region of the busbar section.

### Description of the Background Art

A lead terminal is known, for example, from EP 3 111 513 B1, which corresponds to US 2016/0352028, which is incorporated herein by reference. Such a lead terminal may in particular be designed with multiple spring-loaded clamping connections that are electrically connected to one another and thus form a connection clamp.

### SUMMARY OF THE INVENTION

It is therefore an object of the invention to further improve a lead terminal.

For an exemplary lead terminal, this object is achieved in that the support region of the busbar section has a concavely curved contour. The support region is thus situated in the same busbar section in which the clamping point for connecting the electrical conductor is formed. The support region is thus a region of the busbar section that faces the support surface of the actuating lever, and along which the actuating lever may slide during a swivel movement. The support region is thus situated on the side of the busbar section at which the clamping point is likewise situated, i.e., the side at which the electrical conductor is supported and connected. Further miniaturization of the lead terminal is possible by use of the invention, in particular for a lead terminal for small conductor cross sections, which already have very small dimensions anyway. The overall installation height of the lead terminal may be reduced due to the concavely curved contour of the support region. In addition, the bearing of the actuating lever is improved, and wear that occurs during swiveling is minimized. It is advantageous when the support element has a support surface, with a convexly curved contour, facing the busbar section.

The busbar section or the busbar may have a predominantly flat design in regions that are directly adjacent to the support region. The normals of the busbar section may extend predominantly perpendicularly with respect to the rotational axis of the actuating lever. The busbar section may be continuous, i.e., stepless or without a slot and/or punched edge, between the support region and the clamping point or a conductor guide that encloses the clamping point.

The object mentioned at the outset is also achieved in that the support region of the busbar section can be designed as a depression in the busbar section, which in relation to neighboring flat regions of the busbar section forms a trough-like or channel-like depression. Further miniaturization of the lead terminal is also thus possible. The installation height of the lead terminal may thus be further reduced. In particular, regions in the housing of the lead terminal, below the busbar, that are available but previously unused may be utilized when the depression is produced as an impression in the busbar, which on the side facing away from the support region results in a protrusion of the busbar. In addition, the invention offers the advantage of an at least reduced risk that individual litz wires of a litz wire conductor may become jammed between the support surface at the actuating element and the support region of the busbar section, since the litz wires are in principle supported on a support surface that is elevated with respect to the support region.

As one of the above-mentioned neighboring flat regions of the busbar section, for example a conductor contact region may be present, at which an electrical conductor that is to be connected is to be situated at the clamping point, and rests on the surface of the busbar section. Such a conductor contact region may be designed with a flat surface. For example, a conductor contact region may be situated between two neighboring support regions, designed as depressions, each forming a trough-like or channel-like depression.

Both variants of the invention may also advantageously be combined with one another, in that the depression in the busbar section has a concavely curved contour. However, it is also possible for the depression in the busbar section to have a flat or convexly curved contour.

The depression in the busbar section may, for example, be recessed in relation to the clamping point formed at the busbar section. The depression in the busbar section may have a depth that is at least 20% of the material thickness of the busbar section. Between the support regions, the busbar may be higher over the entire width of the conductor, i.e., extending closer to the rotational axis of the actuating lever than in the depression. The largest dimension (length) of the depression may extend in parallel to the conductor insertion direction. The support elements of the actuating lever, for example in the form of bearing plates, may be guided through the depressions in the busbar, also in the axial direction. The depression in the busbar section may have a depth that is at least 3% or at least 5% of the radius of curvature of the support element of the actuating lever in the region of its support surface. The depression in the busbar section may have a depth that is at most 15% or at most 20% of the radius of curvature of the support element of the actuating lever in the region of its support surface.

Depending on the design of the actuating lever, by use of the invention it is also possible to reduce the load on the bearing of the actuating lever, in particular during swiveling, i.e., during opening or closing.

As a result of the invention, the actuating lever can be embedded better in the busbar section, and as a whole may be moved closer to the busbar section.

Altogether, the invention makes a lead terminal possible that has a flat housing with increased air and creep distances. The support surface of the actuating lever in the support region may be enlarged. The actuating lever as a whole may be designed to be more robust. The invention allows the transfer or absorption of fairly large actuating forces, in particular to/into the busbar, via the actuating lever.

The object mentioned at the outset is also achieved in that at least one test lug is situated at the busbar, and can be electrically contactable by means of a test probe that is inserted into the housing. The test lug, viewed in the conductor insertion direction (L), may be situated, for example, between neighboring spring-loaded clamping connections, so that a flat design, the same as for the recessed support regions, is also facilitated. The test lug may be designed as an angled test lug. The housing may have a test opening through which the test probe may be inserted. The housing may have a test channel into which the test lug protrudes, the test lug being electrically contactable via a test probe that is inserted through the test channel.

The test lug may be formed in one piece with the busbar, or designed as a separate component that is fastened to the busbar. If the busbar has a holding frame, for example, as explained in greater detail below, such a test lug may be situated, for example, between neighboring holding frames. The test lug does not have to be situated directly between the holding frames, and instead may be situated in between with an offset in the conductor insertion direction. The test lug, with a section that is angled relative to the flat region of the busbar, may be oriented perpendicularly with respect to the direction of alignment of the clamping points, for example predominantly parallel to the holding frames. A standard test probe for electrical testing may be used as a test probe. It is also possible to use a screwdriver blade as a tester.

The concavely curved contour of the support region, with regard to its curvature profile, can be adapted to the curvature profile of the convexly curved contour of the support surface. This allows particularly good embedding of the actuating lever in the support region of the busbar section. The actuating lever may have an arch-shaped, convexly curved contour, for example, at the support surface. The support region may have an arch-shaped, concavely curved contour. The radius of curvature of the concavely curved contour may be constant or variable over the entire curved profile. In an example, the radius of curvature of the concavely curved contour of the support region at any point may be at least as great as the radius of curvature of the convexly curved contour of the support surface. For example, the radius of curvature of the concavely curved contour at any point may be at least 10% or at least 20% greater than the radius of curvature of the convexly curved contour of the support surface. In addition, the radius of curvature of the concavely curved contour of the support region, averaged over the curved profile, may, for example, be at least 10% or at least 20% greater than the radius of curvature of the convexly curved contour of the support surface, averaged over the curved profile.

During the swivel movement, the actuating lever is thus allowed a certain amount of play in the concavely curved contour. The rotational axis of the swivel movement of the actuating lever may be a rotational axis that is fixed over the swivel movement, or may be an at least slightly varying rotational axis.

The lead terminal may be designed as a single-pole or multi-pole lead terminal. The lead terminal may also be designed as a plug connector or as part of an electrical plug connector. In this case, the plug connector can have one or more electrical plug contacts. The spring-loaded clamping connection is then electrically connected to at least one plug contact.

For the lead terminal according to the invention, a corresponding concavely curved and/or recessed support region of the busbar section, which with regard to its width essentially (except for tolerances) corresponds essentially to the width of the support element in the region of the support surface, may be associated with a support element or its support surface. Accordingly, the concavely curved contour in the support region and/or the support region formed as a depression in the busbar section may be designed as a comparatively narrow channel whose width is smaller than the length, in each case viewed in the conductor insertion direction of the electrical conductor into the spring-loaded clamping connection.

For a multi-pole lead terminal, the individual busbar sections of the spring-loaded clamping connections may be parts of a continuous busbar. This continuous busbar may be formed in one piece from a metal part, or may be assembled in multiple pieces from multiple metal parts, for example via a form-fit, force-fit, and/or integrally joined connection.

The lead terminal can be designed as a multi-pole lead terminal in which multiple spring-loaded clamping connections are situated next to one another or also opposite one another, the spring-loaded clamping connections each having a clamping spring and a busbar section associated with the clamping spring, and an actuating lever being associated with each spring-loaded clamping connection, the busbar sections being parts of a continuous busbar, and the concavely curved contour of the support region and/or the support region designed as a depression in the busbar section extending continuously from a support element of an actuating lever at least to a support element of a directly neighboring actuating lever, or extending continuously over the busbar sections of multiple or all spring-loaded clamping connections. This has the advantage that the manufacture of the busbar having the concavely curved contours and/or depressions is simplified, since the total number of concavely curved contours and/or depressions to be introduced is decreased, and their width is increased. For example, a concavely curved contour of the support region and/or a support region designed as a depression in the busbar section may be formed in such a way that they/it extend(s) only from a support element of an actuating lever to a support element of a directly neighboring actuating lever, and not beyond. Gaps then result between such concavely curved contours and/or depressions, which advantageously may be correspondingly adapted for other functional purposes, for example to form a clamping point for the electrical conductor.

The continuously extending concavely curved contour of the support region and/or the support region designed as a depression in the busbar section can be at least partially interrupted, at least at one clamping point, by another contour, in particular a clamping contour. This has the advantage that, despite the configuration of the busbar sections with the concavely curved support regions and/or the depressions, the clamping points may be formed particularly advantageously for connecting an electrical conductor.

The actuating lever in the concavely curved contour and/or the depression may be swivelable about a rotational axis (D) that extends transversely with respect to the conductor insertion direction of the associated spring-loaded clamping connection. The curvature of the concavely curved contour or the center axis of this curvature is then oriented transversely with respect to the conductor insertion direction and/or in parallel to the rotational axis.

The busbar section can have a clamping edge for connecting the electrical conductor. This allows particularly secure connection of the electrical conductor to the busbar section. The clamping edge of the busbar section may be designed as a comparatively sharp-edged location that is able to embed slightly in the material of the connected electrical conductor.

The clamping spring of the spring-loaded clamping connection may have a clamping leg, which at the free end may likewise have a clamping edge. The clamping of the electrical conductor to the clamping leg is thus also made more reliable.

The clamping edge of the busbar section, in the conductor insertion direction, can be situated next to or behind the concavely curved contour of the support region and/or the support region designed as a depression in the busbar section. The lead terminal may thus have a particularly compact design, also in the conductor insertion direction.

Also independently of the presence of such a clamping edge of the busbar section, it is advantageous when the clamping point for connecting the electrical conductor to the busbar section in the conductor insertion direction is situated next to or behind the concavely curved contour of the support region and/or the support region designed as a depression in the busbar section. The lead terminal may thus also have a particularly compact design in the conductor insertion direction.

The clamping edge can be designed as a border edge of a depression that is impressed in the busbar section. The clamping edge in the busbar section may thus be easily manufactured with regard to production engineering without the material of the busbar section becoming too greatly weakened or damaged. The depression may have a buckled cross-sectional contour, for example, in particular may have no curved contour as with the support region.

The length of the depression that is impressed in the busbar section, viewed in the conductor insertion direction, can be smaller than the length of the concavely curved contour of the support region and/or of the support region designed as a depression in the busbar section.

The actuating lever can have two spaced-apart support elements, situated in parallel, each of which has a support surface facing the busbar section, for example having a convexly curved contour via which the actuating lever is supported on the support region of the busbar section. The actuating lever is thus securely supported on the busbar section. Even for very compact lead terminals, the actuating lever may have a relatively robust design, and for this reason may transfer high actuating forces to the clamping spring. Alternatively, also more than two spaced-apart support elements situated in parallel may be present, for example when an actuating lever is to be used to simultaneously actuate two clamping springs situated next to one another.

The clamping point of the electrical conductor, and/or if a clamping edge of the busbar section is present, this clamping edge, can be situated in a space that is formed between the two spaced-apart support elements situated in parallel. In this way, use may be made of the space between the support elements for placing the electrical conductor. The lead terminal may thus have a particularly compact design.

The concavely curved contour of the support region and/or the support region can be formed as a depression in the busbar section extends continuously from a support element of an actuating lever at least to the nearest support element of a directly neighboring actuating lever. This has the advantage that, despite the configuration of the busbar sections with the concavely curved support regions and/or depressions, the clamping points may be formed particularly advantageously for connecting an electrical conductor. The concavely curved contour and/or the support region designed as a depression in the busbar section may, for example, extend continuously from a support element of an actuating element only to the nearest support element of a directly neighboring actuating lever, and not beyond.

A receiving space for accommodating the electrical conductor connected to the spring-loaded clamping connection can be formed between the support elements of an actuating lever. In addition, this is beneficial for a particularly small, compact design of the lead terminal. The space encompassed by the actuating lever may thus be advantageously utilized for accommodating the electrical conductor.

At least a portion of the clamping spring, in particular the predominant portion of a clamping leg of the clamping spring, can be situated in a region between the support elements of an actuating lever. This allows a mechanically favorable actuation of the clamping leg of the clamping spring by the actuating lever. For example, the clamping leg, starting from a spring bend in the clamping spring, may initially have a fairly large width, and then toward the free end may taper to a smaller width. In the region of the clamping leg having the larger width, impingement sections of the actuating lever may transfer their actuating forces to the clamping leg.

The actuating lever can have two spaced-apart side wall sections that at least partially immerge into a housing of the lead terminal and that are each connected to one of the support elements via a connecting section. A robust actuating lever that is nested with the housing of the lead terminal and in particular with certain housing walls may be provided in this way. Large air and creep distances may also thus be achieved, even for compact lead terminals. Due to the arrangement of the support elements in the concavely curved contours and/or depressions, additional installation space is provided for a robust design of the transition, at the actuating lever, between the support elements and the side wall sections; i.e., the particular connecting section may be formed using more material, and thus with a more robust design. The actuating lever may, for example, be designed in each case with a side wall section, a connecting section that is connected to the side wall section, and a support element that is connected to the connecting section, resulting in a U-shaped contour. As a result of these contours being present in duplicate (to the left and right of the clamping point), the actuating lever has a double U contour in the region of the support elements.

The support elements can form a rotational axis (D) about which the actuating lever is swivelably supported in the housing, the support elements having actuation sections, each of which is designed for impinging on an associated clamping spring of a spring-loaded clamping connection when the actuating lever swivels from a closed position, in which the actuating lever with its transverse web is swiveled toward the housing, and a clamping point formed by the spring-loaded clamping connection is closed for connecting an electrical conductor, into an open position in which the actuating lever with its transverse web is swiveled away from the housing, and a clamping point formed by the spring-loaded clamping connection is opened for connecting an electrical conductor. This allows reliable actuation of the clamping spring, and at the same time allows a small, compact design of the spring-loaded clamping connection to the actuating lever. According to an example of the invention, when the actuating lever is in its open position it remains there; i.e., it does not automatically move back into the closed position. For example, the actuating lever may be latched in the open position and/or may be in an over-center position.

The impingement sections at the support elements can be spaced less farther apart from one another than the distance between the side wall sections, the impingement sections extending in parallel to the side wall sections and being integrally formed with the side wall sections in such a way that in each case a guide slot is present between an impingement section and the associated directly neighboring side wall section. In each case, a guide web of the housing then immerges into an associated guide slot in order to guide the actuating lever during a swivel movement about a swivel axis in the swivel bearing region.

By use of the impingement sections, which are spaced apart from the side wall sections of the U-shaped lever arm by a guide slot situated in between, the lever arm may be supported in a swivelably tilt-proof manner by a guide web of the housing that immerges into a respective guide slot. With the aid of the guide slots and the guide webs engaging therewith, very stable swivel bearings which lie essentially laterally next to the spring-loaded clamping connections may be achieved in a space-saving manner.

The actuating lever therefore has an approximately U-shaped cross section, and accommodates the spring-loaded clamping connection, at least in part, in the open space that is laterally bordered by the side wall sections. Thus, the swivel bearing regions are not situated above, below, in front of, or behind the spring-loaded clamping connection, but, rather, are situated laterally next to the spring-loaded clamping connection or the clamping spring, to be actuated, of the spring-loaded clamping connection.

A very compact lead terminal is thus achieved in which the actuating lever, with the swivel bearing regions situated laterally next to the spring-loaded clamping connection in the housing, is positionally stable and robustly swivelably supported in the housing.

Due to the interplay of the described measures, an extremely compact lead terminal is achieved, whose swivel levers are swivelably supported in the insulated housing in a stable manner, without the housing being subjected to excessive load due to actuating forces acting on the at least one swivel lever.

In each case, a guide web of the housing may immerge into an associated guide slot in order to guide the actuating lever during a swivel movement about a rotational axis (D) in the swivel bearing region.

The impingement sections can have a partially circular outer circumference with a cutout forming a shoulder that protrudes toward the center of the impingement section, the at least one spring-loaded clamping connection having a clamping spring with an actuating tab, and the actuating tab of the clamping spring resting on the shoulder when the actuating lever is swiveled to open the clamping point. With the aid of such a shoulder which is adjoined by an open space thereabove, a stable support for an actuating tab of the clamping spring is provided, so that the spring actuating force is optimally transferred via the shoulder to the clamping tab of the clamping spring. Due to the shoulder which protrudes toward the center of the impingement section, an open space is provided thereabove, so that the clamping spring may otherwise lift off freely from the shoulder, even without lever actuation, in order to exert a spring clamping force on the electrical conductor without influence by the lever arm. It may thus also be provided that the electrical conductor may be directly inserted without having to deflect the clamping leg via the actuating lever beforehand.

Due to the described design of the lead terminal, the transition from the support element via the transverse web to the side wall section may be enlarged, and at the same time, the air distance from the busbar may be increased, without the lead terminal itself having to have a higher design. In addition, the contact area between the actuating lever and the busbar section may be formed in the manner of a concavely curved, arch-shaped pan. In comparison to the prior art, this contact area may be changed from a pure linear contact to a more strongly flattened contact. The load on the contact area and the wear are thus reduced. In addition, the actuating lever is better guided during the swivel movement.

The depression in the busbar section on at least one side can merge in a stepped manner into a neighboring elevated region of the busbar section, and/or on at least one side merges in a stepless manner into a neighboring elevated region of the busbar section. For example, one or both longitudinal sides of the depression, which extend in parallel to the conductor insertion direction, may merge in a stepped manner into the neighboring elevated region, and the sides extending transversely with respect to the conductor insertion direction may merge in a stepless manner into the neighboring elevated region. A stepped transition may be, for example, a transition with a sharp cut edge that is formed by a tool. A stepless transition may be a smooth transition via a bevel or a rounded contour, for example, i.e., a transition using a continuous material that is deformed without cutting.

Within the meaning of the present invention, the indeterminate term “a” is not to be understood as a numeral. Thus, for example, if a component is being referred to, this is to be interpreted within the meaning of “at least one component.” If angular indications are expressed in degrees, these refer to a circular measure of 360 degrees (360°).

Further scope of applicability of the present invention will become apparent from the detailed description given hereinafter. However, it should be understood that the detailed description and specific examples, while indicating preferred embodiments of the invention, are given by way of illustration only, since various changes, combinations, and modifications within the spirit and scope of the invention will become apparent to those skilled in the art from this detailed description.

### BRIEF DESCRIPTION OF THE DRAWINGS

The present invention will become more fully understood from the detailed description given hereinbelow and the accompanying drawings which are given by way of illustration only, and thus, are not limitive of the present invention, and wherein:

FIG. 1 shows a lead terminal in a perspective illustration,

FIG. 2 shows the lead terminal according to FIG. 1 in a longitudinal section,

FIG. 3 shows a busbar of the lead terminal in a perspective illustration,

FIG. 4 shows the busbar according to FIG. 3 with additional components,

FIG. 5 shows the busbar with additional components, as illustrated in FIG. 4, in a side view,

FIG. 6 shows an example of a busbar in a perspective illustration,

FIG. 7 shows an actuating lever in a perspective illustration,

FIG. 8 shows the actuating lever according to FIG. 7 in a longitudinal section,

FIG. 9 shows an example of a busbar in a perspective illustration,

FIGS. 10 and 11 show the busbar according to FIG. 9 with an actuating lever in different perspective views,

FIG. 12 shows the busbar according to FIG. 9 with clamping springs and actuating levers situated thereon,

FIG. 13 shows a lead terminal designed with the contact insert according to FIG. 12, in a lateral sectional view,

FIG. 14 shows an example of a busbar in a perspective view,

FIGS. 15 and 16 show the busbar according to FIG. 14 with an actuating lever in various perspective views,

FIG. 17 shows the busbar according to FIG. 14 with clamping springs and actuating levers situated thereon, in a perspective illustration,

FIG. 18 shows the lead terminal according to FIG. 1 from the rear side, and

FIG. 19 shows the lead terminal according to FIG. 1 in a further view in the longitudinal section.

### DETAILED DESCRIPTION

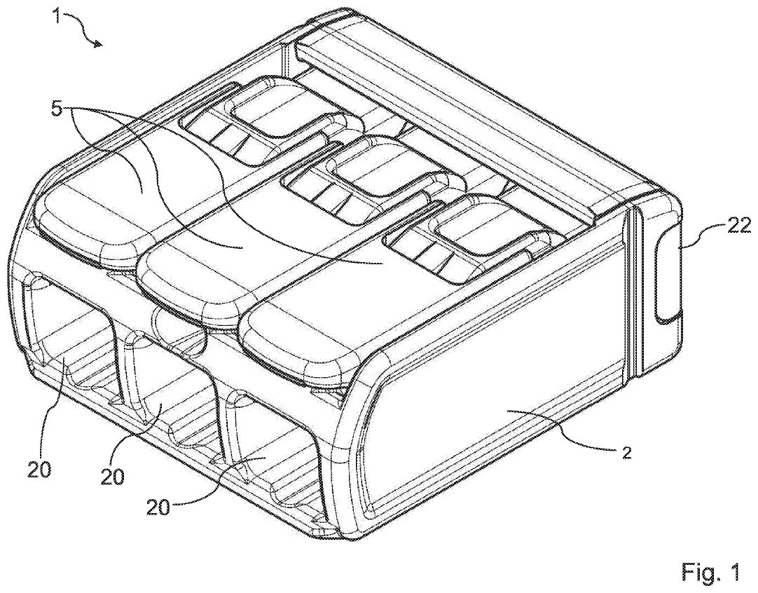

FIG. 1 shows a lead terminal 1, which has a three-pole design here by way of example. The lead terminal 1 has a housing 2 in which three spring-loaded clamping connections are arranged next to one another. A conductor insertion opening 20 in the housing 2 is associated with each spring-loaded clamping connection. An electrical conductor may be guided through the conductor insertion opening 20 to a clamping point of the spring-loaded clamping connection. The lead terminal 1 also has three actuating levers 5. Each actuating lever 5 is associated with one of the spring-loaded clamping connections. The clamping spring of the spring-loaded clamping connection may be actuated by the respective actuating lever, so that the clamping point may be opened or closed as needed.

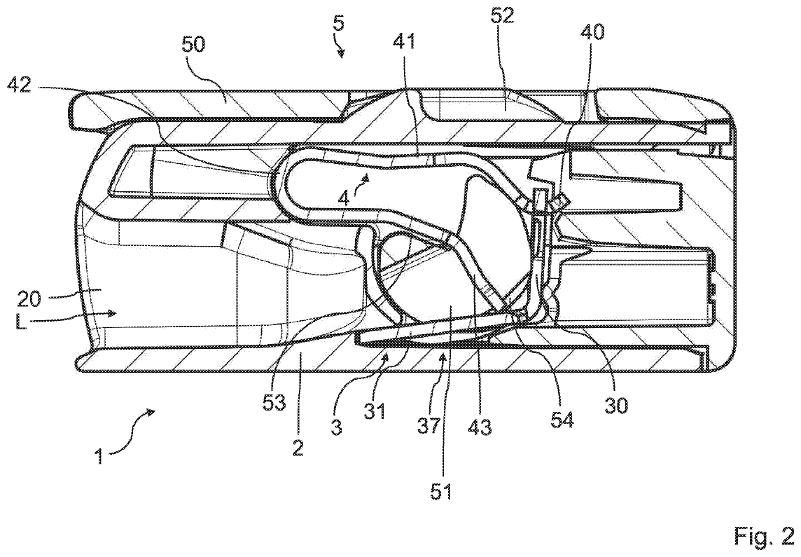

In the sectional illustration in FIG. 2, it is apparent that a respective spring-loaded clamping connection has a clamping spring 4, and a busbar section 37 associated with the clamping spring 4. The clamping spring 4 has a contact leg 41, a spring bend 42 adjoining the contact leg 41, and a clamping leg 43 adjoining the spring bend 42. The contact leg is suspended on a holding frame 30 via a retaining element 40 on the end side. The clamping spring 4 is thus fastened to the holding frame 30 via the contact leg 41 of the clamping spring.

In the illustrated arrangement, i.e., with the actuating lever 5 closed and without a connected electrical conductor, the clamping leg 43 rests against a contact section 31 of its associated busbar section 37. When an electrical conductor is connected, it is connected between the free end of the clamping leg 43 and the contact section 31. The holding frame 30 is connected to the contact section 31, or in the illustrated example is designed in one piece with the contact section. A self-supporting spring-loaded clamping connection is thus formed in which the clamping spring 4 is held on both sides by the busbar 3.

The actuating lever 5 has a manual actuation section 50 at which the actuating lever is manually actuatable to swivel, and in this manner is swivelable. The manual actuation section 50 protrudes at least partially from the housing 2, above the conductor insertion opening 20, so that it may advantageously be gripped more easily. Side wall sections 52 extend from the manual actuation section 50 and into the housing 2. As described in greater detail below, the side wall sections 52 are connected to support elements 51 via which the actuating lever 5 is supported on the busbar 3. The support elements 51 have impingement sections 53 that are used for the mechanical impingement and accordingly for deflection of the clamping leg 43 when the actuating lever 5 is swiveled. When the actuating lever 5 is swiveled into the open position (with respect to the illustrated arrangement, about a certain angle in the clockwise direction), the impingement section 53 comes into contact with the clamping leg 43 and lifts it away from the busbar section 37. The clamping point is opened in this way. An electrical conductor may then be inserted through the conductor insertion opening 20 in a conductor insertion direction L without applying force to the clamping point between the clamping leg 43 and the busbar section 37. The electrical conductor may then be clamped there by swiveling the actuating lever 5 back into the closed position (as illustrated in FIG. 2).

The actuating lever 5 is supported on the busbar section 37 via its support elements 51, more precisely, via its support surfaces 54 facing the busbar section 37. As is apparent in the sectional illustration in FIG. 2, the support surface 54 extends into the illustrated section plane of the busbar section 37, which is situated at the recessed support regions present in the busbar section 37, as explained in greater detail below.

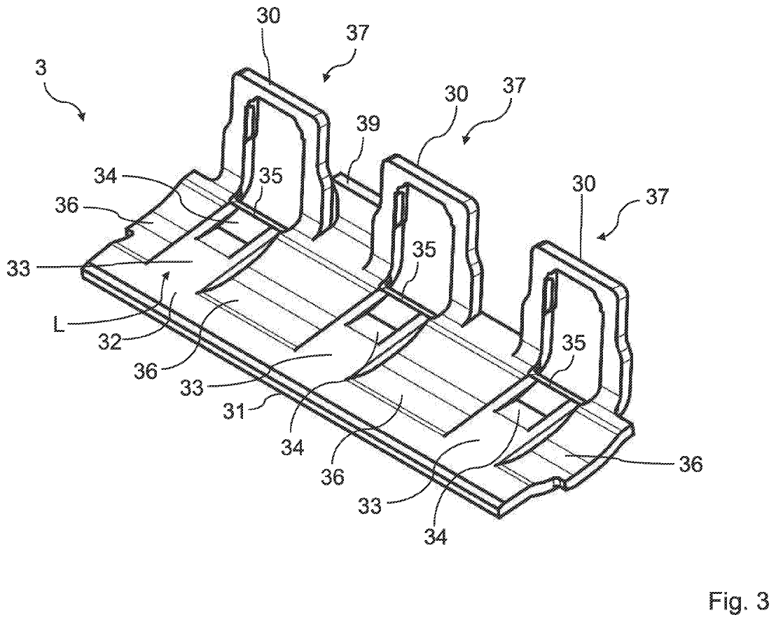

FIG. 3 shows the busbar 3 of the above-described lead terminal 1 as an individual part. It is apparent that the busbar 3 for each of the three spring-loaded clamping connections has a respective busbar section 37. The contact section 31 is thus structured into three busbar sections 37. At one side of the busbar 3, the contact section 31 merges into a respective holding frame 30 of the particular busbar section 37. As mentioned, the clamping springs 4 with their retaining elements 40 are suspended on the holding frame 30.

The busbar 3 has a flat region 32 in the contact section 31. Opposite from this flat region 32, support regions 36 and clamping contours 34 have a recessed design, for example by impressing with an embossing tool. The clamping contours 34 are used for connecting the electrical conductor in the particular busbar section 37. A clamping edge 35 of the particular busbar section 37 is formed in each case at the rear end of a clamping contour 34, in the conductor insertion direction L.

The support regions 36 are used for accommodating and supporting the support elements 51 of the actuating levers 5. The support regions 36 each have a concavely curved contour that extends in an arched shape, for example. The individual support regions 36 are interrupted in each case by conductor contact regions 33 at which the electrical conductors to be connected are situated. The conductor contact regions 33 may, for example, have a flat shape that is comparable to the flat region 32; i.e., they may be designed with a flat surface. In addition, one of the above-mentioned clamping contours 34 may be situated in each conductor contact region 33.

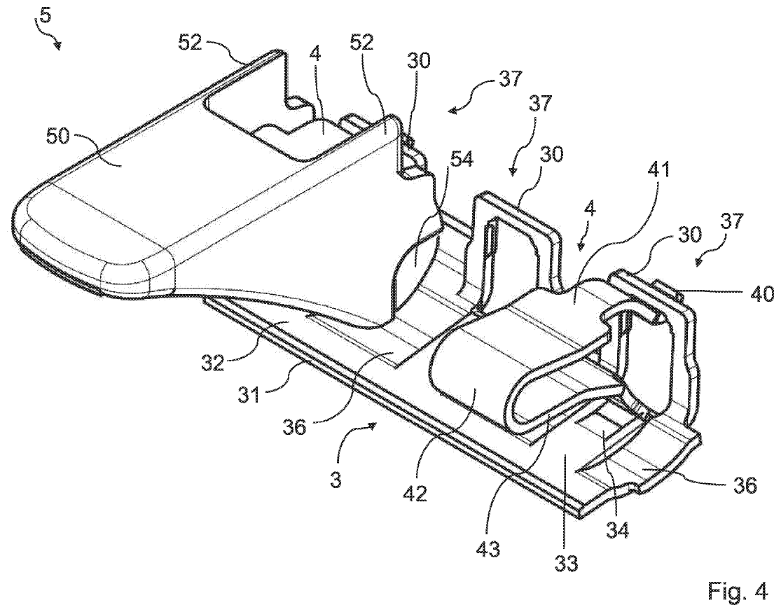

FIG. 4 shows the busbar 3 according to FIG. 3 with a clamping spring 4 suspended on the right busbar section 37, as well as a busbar section 37 at the far left with an actuating lever 5 and a clamping spring 4 suspended there. It is apparent how the actuating lever 5 with the support surface 54 of the support element 51 is well inserted into the concavely curved support regions 36, and may slide along the support regions 36 during a swivel movement.

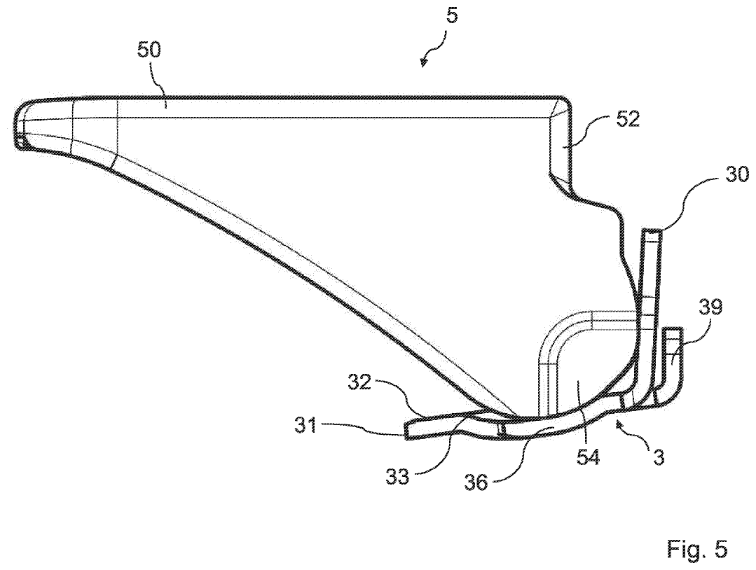

FIG. 5 shows this advantageous adaptation of the concavely curved contour of the support surface 54, and the convexly curved contour of the support region 36, whose shape is adapted thereto, in a side view.

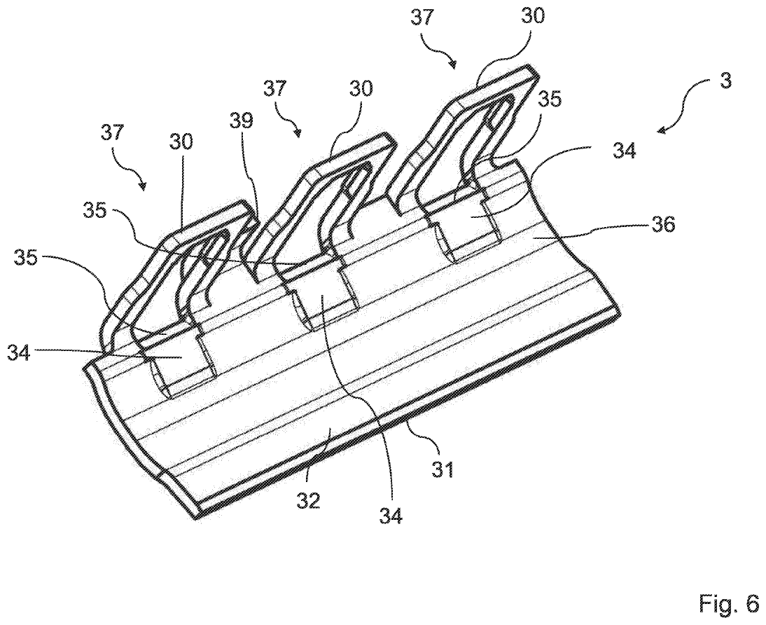

FIG. 6 shows a design of a busbar 3 in which the support region 36 with the convexly curved contour extends continuously over the entire width of the busbar 3. The concavely curved contour is partially interrupted by clamping contours 34, which are elevated with respect to the convexly curved contour solely in the rear regions in the conductor insertion direction L. Here as well, a clamping edge 35 of the particular busbar section 37 is once again formed at the respective rear end of a clamping contour 34 in the conductor insertion direction L.

A perspective view of an actuating lever 5 from the bottom side is apparent in FIG. 7. The example having a U-shaped cross section in principle, with two spaced-apart side wall sections 52 which at their free end are connected to one another at a side edge via a transverse web 59, is discernible here. It is clear that the side wall sections 52 taper from the swivel bearing regions 62 toward the free end. It is apparent that an actuation ridge 60 is present at the free end of the transverse web 59. It is also clear that the transverse web 59 with the actuation ridge 60 protrudes toward the front, beyond the free ends of the side wall sections 52, the inner sides of the transverse web 59 extending at an angle at the free end edge. Slipping during application of a lever actuation force by the actuating lever 5 is thus counteracted.

It is also apparent that partially circular sections that form the respective support elements 51 are spaced apart from the side wall sections 52 in the swivel bearing region 62 via a guide slot 57. A receiving space 58 for accommodating the electrical conductor that is connected to the spring-loaded clamping connection is formed between the support elements 51. It is also apparent that the support elements 51 have outer end faces, curved in a partially circular shape, that form support surfaces 54 via which the actuating lever 5 is supported on the support regions 36 and is swivelable about a virtual rotational axis D in the housing. The rotational axis D extends through the center of a partial circle that is formed by the support surface 54.

The support elements 51 each have a V-shaped notch 56. An impingement section 53 that is used for impingement of a spring actuating force on an associated clamping leg 43 of a clamping spring 4 is provided in each case in the region of the V-shaped notches 56. It is apparent that the impingement sections 53, the same as the transverse web 59 on which a lever swivel force is exerted, are situated on the same side relative to the rotational axis D, viewed in the longitudinal extension direction of the side wall sections 52. As a result, the spring actuating forces exerted via the actuation sections 50 act on the same side relative to the rotational axis D as the lever swivel force that is applied to the transverse web 59 for swiveling.

It is also apparent that a detent lug 61 protrudes from the transverse web 59 on the side opposite from the actuation ridge 60, approximately in the direction of the swivel bearing region 62 and the support element 51. The detent lug 61 is used to latch the actuating lever 5 to the housing 2 in the closed position.

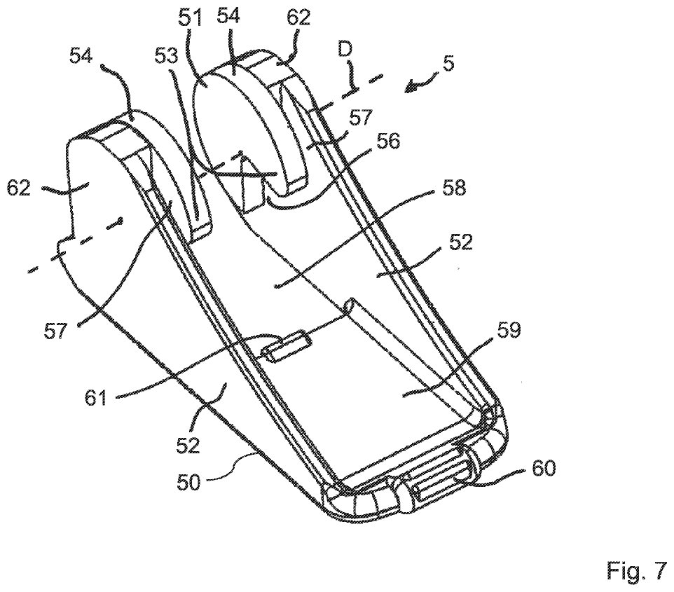

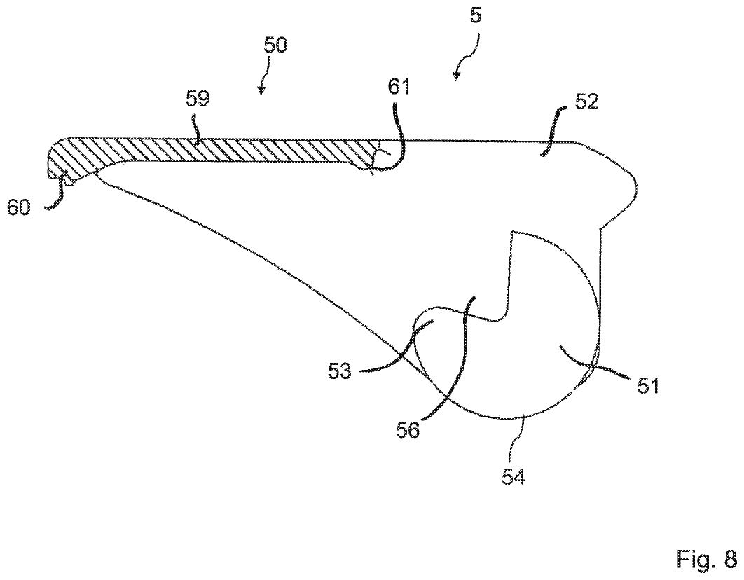

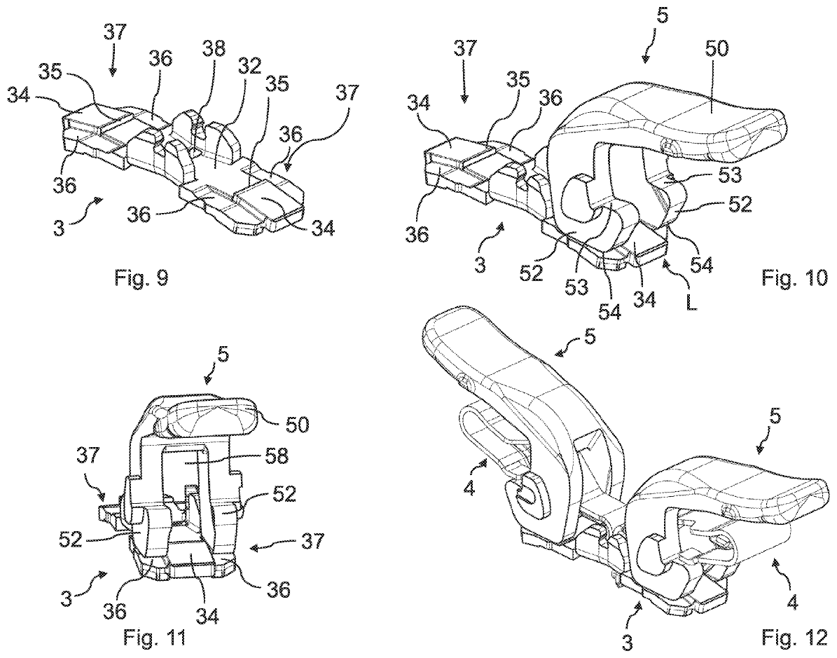

FIG. 8 shows a lateral sectional view of the actuating lever 5 from FIG. 7. Once again, it is clear that the side wall sections 52 are connected at the top side of the actuating lever 5 by a transverse web 59 that connects the side wall sections. The transverse web 59 extends over only a partial region of the length of the side wall sections 52, and preferably occupies more than one-half the length of the side wall sections 52.

Whereas in the above-described examples of the lead terminal, the busbar sections 37 were each designed with support regions 36 having a concavely curved contour, based on the following examples according to FIGS. 9 through 17 an example is described in which the support regions 36 are each designed as a depression in the busbar section 37, without having a concavely curved contour.

The examples according to FIGS. 9 through 17 are based on a configuration of the lead terminal 1 in which the conductor insertion openings are situated not just on one side of the housing, but, rather, on oppositely situated housing sides (facing away from one another). Accordingly, the busbar 3 also has a double-sided design, i.e., with respective busbar sections 37 situated on opposite sides. A respective busbar section 37 has a clamping contour 34 for connecting the electrical conductor, the clamping contour having a clamping edge 35 at the rear end in the conductor insertion direction L. The busbar 3 has a flat region 32 between the oppositely situated clamping contours 34. Support regions 36 for supporting an actuating lever 5 are present which are designed as depressions with respect to this flat region 32, a support region 36 being formed in each case to the left and to the right of a clamping contour 34. The support region 36 extends in the conductor insertion direction L, from a region in front of the clamping edge 35 into a region behind the clamping edge 35.

The busbar 3 is designed without the above-described holding frames 30 for holding the clamping springs. Instead, a retaining recess 38 is present in the flat region 32, i.e., between the oppositely situated clamping contours 34, in which the clamping springs 4 may be suspended via an extended region of the contact leg 41 at which a retaining element 40 is situated.

FIG. 10 illustrates the arrangement of an actuating lever 5 with its support surfaces 54 on the support regions 36. FIG. 11 shows the bearing of the actuating lever 5 similarly as in FIG. 10, but in a different viewing direction in which in particular the receiving space 58 for accommodating the electrical conductor is discernible. FIG. 12 shows an arrangement with the busbar 3 according to FIG. 9, two clamping springs 4 fastened thereto, and actuating levers 5 for actuating the respective clamping springs 4.

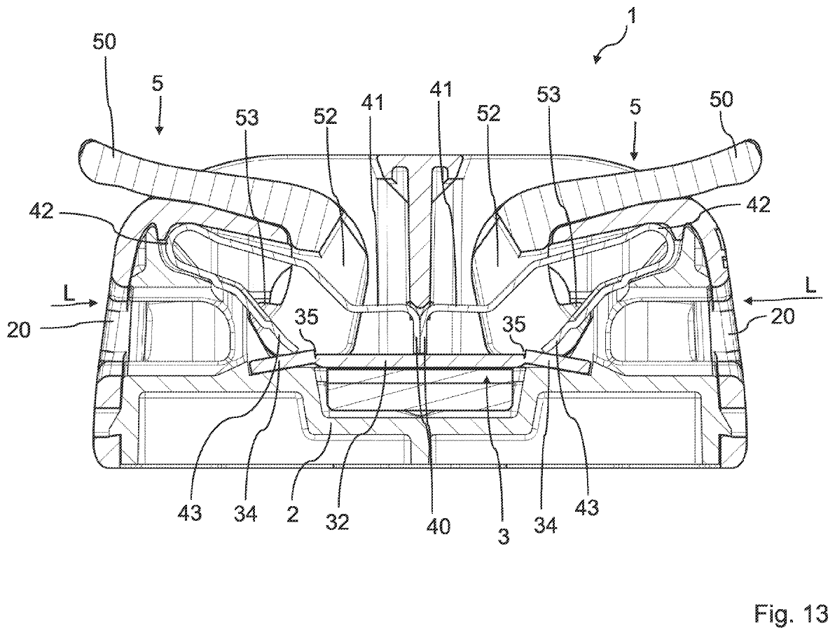

FIG. 13 shows a lead terminal 1 in which an arrangement according to FIG. 12 is installed. Apparent in particular is the fastening of the clamping springs 4 via end-side retaining elements 40 which are present at each of the contact legs 41, and which are suspended in the retaining recess 38 in the flat region 32 of the busbar 3. The clamping springs 4 may be deflected by impingement on respective actuation surfaces of the clamping leg 43, in that when the respective actuating lever 5 swivels, its impingement sections 53 come into contact with the actuation surfaces, thus moving the respective clamping leg 43 away from the busbar 3.

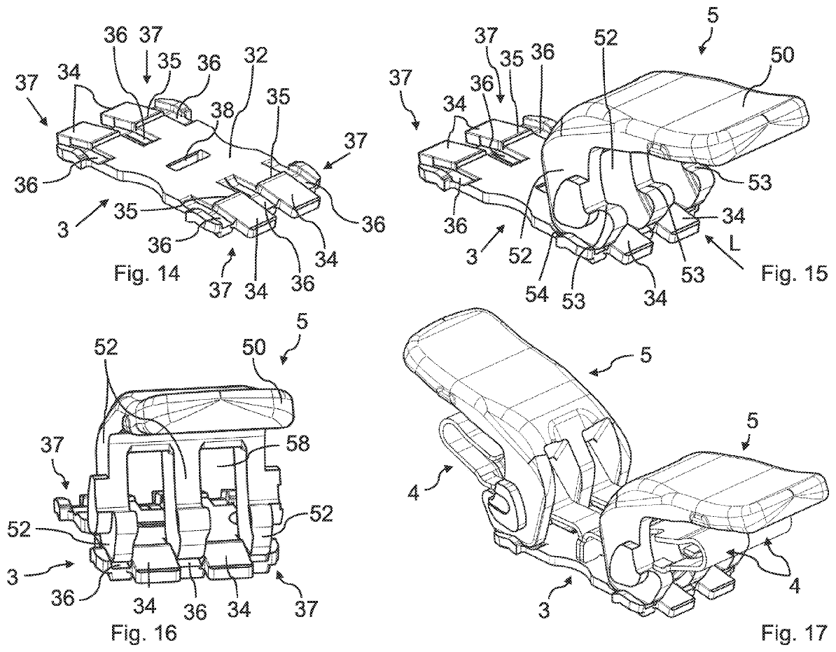

FIGS. 14 through 17 show a further example of a busbar 3, as well as further elements of the lead terminal in which, in contrast to the examples in FIGS. 9 through 12, multiple (in the present case, two) busbar sections 37 are situated next to one another on each side of the busbar 3. In other respects, the busbar 3 is similar to the one provided in the examples in FIGS. 9 through 12, in particular with the retaining recess 38 in the flat region 32 of the busbar 3. It is also apparent that for the busbar sections 37 situated on one side of the busbar 3, the particular center support region 36 forms a shared, continuous depression; i.e., individual depressions are not formed there for each busbar section 37, but instead a shared depression is formed. As is apparent with reference to FIGS. 15 and 16, for example, the actuating lever 5 for this center region has a wide side wall section 52 that extends at least essentially over the entire width of the recessed support region 36.

In particular for the examples according to FIGS. 9 through 17, it is not absolutely necessary for the conductor insertion openings to be situated on opposite housing sides. The conductor insertion openings may also be provided on only one side of the housing 2. In addition, instead of a single actuating lever 5, two separate actuating levers 5 for the various clamping points may be provided on a housing side. It is also conceivable for more than two conductor insertion openings and corresponding clamping points to be present on a housing side. In the examples according to FIGS. 1 through 8, conductor insertion openings may also be present on opposite housing sides. Accordingly, the busbar 3 is then to have a double-sided design.

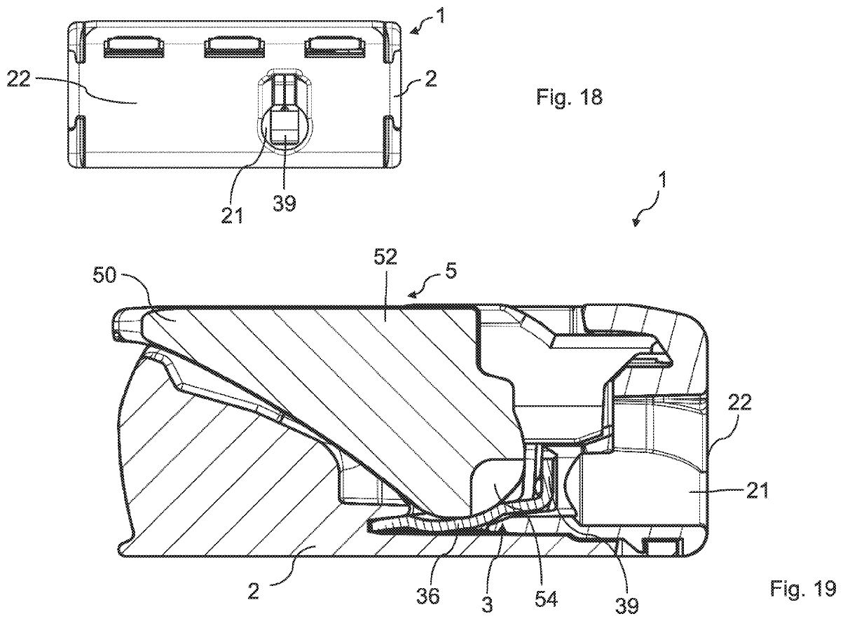

A further independent variant of the invention relates to a lead terminal 1 of the type mentioned at the outset, in which at least one test lug 39 is situated at the busbar 3. This example is illustrated in FIGS. 3, 4, 5, 6 and in FIGS. 18 and 19. The test lug 39 is used for electrical contacting, and thus for carrying out electrical measurements at the busbar by means of a test probe. It is apparent in FIG. 3 that the test lug 39 is situated between two holding frames 30, and is slightly recessed with respect to these holding frames in the conductor insertion direction L, i.e., is situated behind the holding frames 30 in the conductor insertion direction L. This is likewise illustrated in FIG. 5. In addition, it is apparent that the test lug 39 is formed in one piece with the busbar 3, and initially runs in an extension of the flat region 32 to behind the holding frames 30, and at that location merges, via a curve, into a section that extends essentially perpendicularly with respect to the flat region 32.

FIG. 18 shows the lead terminal 1 with the housing 2 in a view of the housing rear side 22. FIG. 19 shows the lead terminal 1 in a sectional view comparable to FIG. 2, but in a section plane through the test lug 39. A test opening that merges into a test channel 21 is situated at the housing rear side 22. The test channel 21 leads to the test lug 39. A test probe may now be guided through the test opening and the test channel 21 at the test lug 39, and may electrically contact it. In its longitudinal direction, the test channel 21 extends essentially perpendicularly with respect to the direction of alignment of the clamping points.

The invention being thus described, it will be obvious that the same may be varied in many ways. Such variations are not to be regarded as a departure from the spirit and scope of the invention, and all such modifications as would be obvious to one skilled in the art are to be included within the scope of the following claims.

What is claimed is:

1. A lead terminal comprising:
at least one spring-loaded clamping connection for connecting an electrical conductor by spring force, the spring-loaded clamping connection comprising:
a clamping spring; and
a busbar section associated with the clamping spring), between which a clamping point for connecting the electrical conductor is formed; and
a swivelable actuating lever associated with the spring-loaded clamping connection to actuate the clamping spring, the actuating lever having at least one support element that includes a support surface facing the busbar section, via which the actuating lever is supported on a support region of the busbar section,
wherein the support region of the busbar section is formed as a depression in the busbar section, which in relation to neighboring flat regions of the busbar section forms a trough-like or channel-like depression.

2. The lead terminal according to claim 1, wherein a depth of the depression in the busbar section is formed in relation to the clamping site formed at the busbar section.

3. The lead terminal according to claim 1, wherein the depression in the busbar section has a depth that is at least 20% of the material thickness of the busbar section.

4. The lead terminal according to claim 1, wherein the lead terminal is designed as a multi-pole lead terminal in which multiple spring-loaded clamping connections are situated next to one another, wherein the spring-loaded clamping connections each have a clamping spring and a busbar section associated with the clamping spring, wherein an actuating lever is associated with each spring-loaded clamping connection, wherein the busbar sections are parts of a continuous busbar, and wherein the support region designed as a depression in the busbar section extends continuously from a support element of an actuating lever at least to a support element of a directly neighboring actuating lever or extends continuously over the busbar sections of multiple or all spring-loaded clamping connections.

5. The lead terminal according to claim 1, wherein the support region formed as a depression in the busbar section is at least partially interrupted, at least at one clamping point, by another contour or a clamping contour.

6. The lead terminal according to claim 1, wherein the actuating lever in the support region designed as a depression in the busbar section is swivelable about a rotational axis that extends transversely with respect to the conductor insertion direction of the associated spring-loaded clamping connection.

7. The lead terminal according to claim 1, wherein the busbar section has a clamping edge for connecting the electrical conductor.

8. The lead terminal according to claim 7, wherein the clamping edge of the busbar section, in the conductor insertion direction, is arranged next to or behind the support region formed as a depression in the busbar section.

9. The lead terminal according to claim 7, wherein the clamping edge of the busbar section is designed as a border edge of a depression that is impressed in the busbar section.

10. The lead terminal according to claim 9, wherein a length of the depression that is impressed in the busbar section, viewed in the conductor insertion direction, is smaller than a length of the support region designed as a depression in the busbar section.

11. The lead terminal according to claim 1, wherein the actuating lever has two spaced-apart support elements, arranged in parallel, each of which has a support surface facing the busbar section via which the actuating lever is supported on the support region of the busbar section.

12. The lead terminal according to claim 11, wherein the support region formed as a depression in the busbar section extends continuously from a support element of an actuating lever at least to the nearest support element of a directly neighboring actuating lever.

13. The lead terminal according to claim 11, wherein a receiving space for accommodating the electrical conductor connected to the spring-loaded clamping connection is formed between the support elements of an actuating lever.

14. The lead terminal according to claim 11, wherein at least a portion of the clamping spring or a predominant portion of a clamping leg of the clamping spring is arranged in a region between the support elements of an actuating lever.

15. The lead terminal according to claim 11, wherein the actuating lever has two spaced-apart side wall sections that at least partially immerge into a housing of the lead terminal and that are each connected to one of the support elements via a transverse web.

16. The lead terminal according to claim 15, wherein the support elements form a rotational axis about which the actuating lever is swivelably supported in the housing, wherein the support elements have actuation sections, each of which is designed for impinging on an associated clamping spring of a spring-loaded clamping connection when the actuating lever swivels from a closed position, in which the actuating lever with its transverse web is swiveled toward the housing, wherein a clamping point formed by the spring-loaded clamping connection is closed to connect an electrical conductor into an open position in which the actuating lever with its transverse web is swiveled away from the housing, and wherein a clamping point formed by the spring-loaded clamping connection is opened for connecting an electrical conductor.

17. The lead terminal according to claim 16, wherein the actuation sections at the support elements are spaced less farther apart from one another than a distance between the side wall sections, wherein the actuation sections extend in parallel to the side wall sections and are integrally formed with the side wall sections such that at least one guide slot is present between an actuation section and the associated directly neighboring side wall section.

18. The lead terminal according to claim 17, wherein a guide web of the housing immerges into an associated guide slot in order to guide the actuating lever during a swivel movement about a rotational axis in the swivel bearing region.

19. The lead terminal according to claim 16, wherein the actuation sections have a partially circular outer circumference with a cutout forming a shoulder that protrudes toward the center of the actuation section, wherein the at least one spring-loaded clamping connection have a clamping spring with an actuating tab, and wherein the actuating tab of the clamping spring rests on the shoulder when the actuating lever is swiveled to open the clamping point.

20. The lead terminal according to claim 1, wherein the support region of the busbar section has a concavely curved contour.

21. The lead terminal according to claim 20, wherein the concavely curved contour of the support region, with regard to its curvature profile, is adapted to the curvature profile of the convexly curved contour of the support surface.

22. The lead terminal according to claim 1, wherein the depression in the busbar section, on at least one, side merges in a stepped manner into a neighboring elevated region of the busbar section and/or, on at least one side, merges in a stepless manner into a neighboring elevated region of the busbar section.
